(19) United States
(12) Patent Application Publication
(10) Pub. No.: US 2016/0367891 A1
(43) Pub. Date: Dec. 22, 2016

(54) System and Method for Positioning, Tracking and Streaming in an Event

(71) Applicant: Broadview International Pte. Ltd., Singapre (SG)

(72) Inventor: Rajiv Trehan, Tokyo (JP)

(21) Appl. No.: 14/740,256

(22) Filed: Jun. 16, 2015

(51) Int. Cl. A63F 13/213; G06F 3/01; A63F 13/212

(52) U.S. Cl. CPC A63F 13/213; A63F 13/212; G06F 3/011

(57) ABSTRACT

A system for positioning, tracking and streaming progress of participant or player and event in real-time comprises at least one tracking device; tag or Mac address associated with the tracking device; at least one antenna or personal device that detects signal or telemetry information of the tracking device and transmit location information of said tracking device to server(s); plurality of cameras positioned at multiple location relative to route or playing ground focusing on participant or player and operative to stream video of the participant or player and the event; and a server(s) configured to provide real time positioning, tracking and streaming of participant or player and delivering streams for progress of the participant or player and the event in live on web interface configured with custom player.

### FIELD OF THE INVENTION

The present invention relates generally for tracking and streaming live progress of participant or player in an event. More particularly, the present invention may be embodied as tracking location of participant or player in sporting event and delivering a customized stream of their progress in real time.

### BACKGROUND OF THE INVENTION

Millions of people every day follow sports or marathons. Sports or marathons fans are captivated by their interests with particular participant or player or the unique abilities of the individual participant or player, as well as of groups or teams. As a result, there has been an interest in tracking participant or player at event such as sports or marathons by fans, friends, family members or colleagues.

Systems that track participant or player in an event, are known, which discloses systems and methods to facilitate autonomous image capture and picture production. A tracking unit is attached to each tracked object (e.g., participant or player). A tracking device receives location information from each tracking unit. A camera control device controls, based upon the location information, at least one camera or more camera to capture image or video data of event as well as participant or player.

It is also known to manually create video and still images of an event as well as participant or player. For example, a video feed of an event is typically generated by highly trained camera persons and highly trained production staff who select camera shots and combine graphics into the video feed.

By today's standards, a multi-media sporting event broadcast that typically be viewed live through a television or through internet includes at least the following information: video of the event preferably spliced together from multiple views; audio of the event; graphic overlays of key statistics such as the score and other basic event metrics.

However, the available technologies are not fully automatic systems for creating sports broadcasts. There are many drawbacks to the current systems and methodologies some of which are identified as follows: the cost of creating such broadcasts are significant for practical reasons such as equipment and labor costs; the number of filming cameras is limited; the typical broadcaster relies upon manually operated filming cameras to anticipate and follow the event progress, but in practice it is difficult to consistently capture the each progress step by step.

There are a number of patents that discuss tracking several objects and streaming video. But these are mostly for building density maps and tracking of player or building aggregate motion based on tracking information.

There is currently no practical means of creating a complete progress of events including progress in participant or player that can be best used by fans, friends, family members or colleagues or other individuals to track progress of the event and participant or player of his/her choice. While some systems can automatically film the event, they cannot additionally anticipate action based upon the knowledge of tracked participant or player or direct other cameras to follow these tracked participant or player; current systems cannot provide automatically real time custom streams of participant or player for fans, friends, family members or colleagues and other individuals during progress of events.

Also, in event like marathon, only the progress and performance of the top runners is tracked and streamed to viewers. The reasons are there are too many participants to be able to track and place a camera on every runner consistently through the race are difficult. It is impossible to manage a custom stream for every participant in large scales supporting event using custom Camera.

Current broadcasts are primarily designed to be output through a television and are therefore limited especially to the TV's display and computational shortcomings while targeted for television output, broadcasts are not designed to take advantage of current computer technology that is now able to generate realistic graphic renderings on networking sites or social networking sites and surrounding environments in real-time; current broadcasts are not interactive thereby allowing the viewer to dynamically select between multiple video feeds to be viewed either singularly or in combination.

Currently, there are no fully, or even semi-automatic systems for creating a video and/or audio broadcast of progress of individual participant or player in a sporting event.

None of patents or ideas are aimed at providing a personal streaming and media experience for multiple participants of an event or activity to a multiple viewer groups, from the fixed camera streams.

There are several patents that combine some aspect of tracking location and camera feeds. The main disadvantage of all known systems and methods is that none provide a “non-intrusive” way to track, identify and capture the progress of participant or player and event in real-time. There is therefore a need for, and it would be advantageous to have “non-intrusive” system and methods to track, identify and capture the progress of participant or player and event in real-time. It would further be advantageous to have the captured progress and other attributes of the event be transferable in real time to a computer game or networking sites in order to provide much more realistic, higher fidelity for fans, friends, family members or colleagues or other individuals.

Therefore, what is needed is a system or method capable of extracting the tracking information and video streams of participant or player in real-time and also creating a video streams of progress of event as well as progress of participant or player in the event. Moreover, in large scales such as 10,000s participant or player in an event would extract tracking information of each participant or player and their progress to a multiple viewer groups. Also generate family and friends viewing groups on Social Media or social networking sites to track or view the live streaming of the event.

### SUMMARY OF THE INVENTION

The object of the present invention is for tracking up to large scales, for example 10,000s of participant or player in the sport event using tracking device. The tracking device can be attached to clothes or wore by the participant or player and also can be affixed to accessories carried by participant or player. The tracking device can be also attached to other individuals associated with the event such as but not limited to sponsor(s), event manager(s) or organizer(s). This tracking device is combined with fixed streams to link participant or player to a particular stream at a particular point in time. Multiple Viewers can be invited by the participant or player being tracked to watch their progress as if they were being followed by plurality of camera.

For a sport event like a Marathon, a route or playing ground would be lined with plurality of camera. The participant or player is/are tracked using BLE or NFC or RFID or GPS satellite or some other similar technology. The tracking information is sent to the cloud as referred herein as server(s) and then relayed in real-time to web interface configured with custom player. The web interface is linked to Social Media or other server application in which the participant or player tracker is associated.

In one embodiment of the present invention is a system for positioning, tracking and streaming event, comprising: at least one tracking device; at least one antenna which detects signal or telemetry information of the tracking device; plurality of cameras positioned at multiple location relative to route or playing ground focusing on participant or player and operative to stream video of the participant or player and the event; one or more processors which is in communication with tracking device, antenna and plurality of cameras; and server(s) configured to provide real-time positioning, tracking and streaming of participant or player and delivering streams for progress of the participant or player and the event in live on web interface configured with custom player.

Alternatively, the present invention is a system for positioning, tracking and streaming the event by the present invention comprising: at least one tracking device; a personal device such as mobile phone; plurality of cameras positioned at multiple location relative to route or playing ground focusing on participant or player and operative to stream video of the participant or player and the event; one or more processors which is in communication for tracking device, personal device and plurality of cameras; and server(s) configured to provide real-time positioning, tracking and streaming of participant or player and delivering streams for progress of the participant or player and the event in live on web interface configured with custom player.

The personal device such as mobile phone having internet connection can use local tracking of BLE or NFC or RFID or GPS satellite or similar technology such as WPS or WIFI position system for locating the tracking device and then transmitting the location of the tracking device to cloud or server(s) using internet network of that personal device.

An advantage of the present invention is that for positioning, tracking and streaming progress of participant or player and event in real-time.

It would further be advantageous to have the captured progress and other attributes of the event be transferable in real time to a computer game or networking sites in order to provide much more realistic, higher fidelity for viewers including fans, friends, family members or colleagues

It would further be advantageous of the present invention is that fans, friends, family members or colleagues can track or view the live streaming of the event and progress of the participant or player on multiple viewing groups such as on Social Media or social networking sites.

### BRIEF DESCRIPTION OF THE DRAWINGS

The following invention will be described with reference to the following drawings. The drawings and the associated descriptions are provided to illustrate embodiments of the invention and not to limit the scope of the invention:

In the Figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 shows a block diagram of a system for positioning, tracking and streaming participant or player, in which various embodiment of the present invention may be practiced.

FIG. 2 shows a block diagram of a system for positioning, tracking and streaming participant or player and delivering streams for progress of the participant or player and the event on web interface for live broadcasting, in which various embodiment of the present invention may be practiced.

FIG. 3 shows the method of positioning, tracking and streaming tracking participant or player, in which various embodiment of the present invention may be practiced.

FIG. 4A is an exemplary schematic diagram of effective placements of participant or player, antenna and camera in a marathon race event following a predetermined path at a time A.

FIG. 4B is an exemplary schematic diagram of video streams of participant or player of FIG. 4A.

FIG. 4C is another exemplary schematic diagram of effective placements of participant or player, antenna and camera in a marathon race event following a predetermined path at a time B.

FIG. 4D is an exemplary schematic diagram of video streams of participant or player of FIG. 4C.

### DETAILED DESCRIPTION OF THE INVENTION

The present invention will be described with respect to particular embodiments and with reference to certain drawings but the invention is not limited thereto but only by the claims. The drawings described are only schematic and are non-limiting. In the drawings, the size of some of the elements may be exaggerated or distorted and not drawn on scale for illustrative purposes. Where an indefinite or definite article is used when referring to a singular noun e.g. “a” or “an”, “the”, this includes a plural of that noun unless something else is specifically stated.

The present invention now will be described more fully hereinafter with reference to the accompanying drawings, in which some, but not all embodiments of the inventions are shown. While the following description details the preferred embodiments of the present invention is not limited in its application to the details of construction and arrangement of the parts illustrated in the accompanying drawings.

With reference to the figures, numerical designation has been given for each element to facilitate the reader's understanding of the present invention, and particularly with reference to the embodiments of the present invention illustrated in the figures; various preferred embodiments of the present invention are set forth below. The enclosed description and drawings are merely illustrative of preferred embodiments and represent several different ways of configuring the present invention. Although specific components, materials, configurations and uses of the present invention are illustrated and set forth in this disclosure, it should be understood that a number of variations to the components and to the configuration of those components described herein and in the accompanying figures can be made without changing the scope and function of the invention set forth herein.

The present invention provides tracking of participant or player in an event using a tracking device configured with but not limited to BLE or NFC or RFID or GPS satellite. These BLE or NFC or RFID or GPS satellite comprises meta-data for tag or Mac address which is/are detected by an antenna and transmit the location of the tracking device to cloud or server(s). In another way, a personal device such as mobile phone having internet connection can use local tracking of BLE or NFC or RFID or GPS satellite or similar technology such as WPS or WIFI position system for locating the tracking device and then transmitting the location of the tracking device to cloud or server(s) using internet network of that personal device.

This tracking device is combined with fixed streams to link participant or player to a particular stream at a particular point in time. Multiple Viewers can be invited by the participant or player being tracked to watch their progress as if they were being followed by plurality of camera.

For a sport event like a Marathon, a route or playing ground would be lined with plurality of camera. The participant or player is/are tracked using BLE or NFC or RFID or GPS satellite or some other similar technology. The tracking information is sent to the cloud as referred herein as server(s) and instantly appeared on web interface configured with custom player. The web interface is linked to Social Media or other server application in which the participant or player tracker is associated. The web interface in subscribes and unsubscribe to the fixed location stream in synchronization with the tracking information. Thereby, allowing a custom feed of each participant or player for multiple viewers to track.

In one embodiment of the present invention is a system for positioning, tracking and streaming event, comprising: at least one tracking device; at least one antenna which detects signal or telemetry information of the tracking device; plurality of cameras positioned at multiple location relative to route or playing ground focusing on participant or player and operative to stream video of the participant or player and the event; one or more processors which is in communication for tracking device, antenna and plurality of cameras; and server(s) configured to provide real-time positioning, tracking and streaming of participant or player and delivering streams for progress of the participant or player and the event in live on web interface configured with custom player.

The antenna collects telemetry information such as one or more position data, speed data and direction data from tracking device.

Similarly, a personal device collects telemetry information such as one or more position data, speed data and direction data from tracking device.

The real-time tracking in live is obtained by continuous identification of tracking device associated with participant or player in the event. The continuous identification is achieved either here with antenna or personal device.

Therefore, in an alternative way of positioning, tracking and streaming the event by the present invention comprising: at least one tracking device; a personal device such as mobile phone; plurality of cameras positioned at multiple location relative to route or playing ground focusing on participant or player and operative to streaming video of the participant or player and the event; one or more processors which is in communication for tracking device, personal device and plurality of cameras; and server(s) configured to provide real-time positioning, tracking and streaming of participant or player and delivering streams for progress of the participant or player and the event in live on web interface configured with custom player.

The embodiments of the present invention provide tracking up to large scales, for example 10,000s of participant or player in the sport event using tracking device. The tracking device can be attached to clothes or wore by the participant or player and also can be affixed to accessories carried by participant or player. The tracking device can be also attached to other individuals associated with the event such as but not limited to sponsor(s), event manager(s) or organizer(s).

The tracking device is attached to or wore by a participant or player and also can be attached to or wore by others associated with the event such as but not limited to sponsors, event manager or organizer for identifying signal or telemetry information and progress with change in telemetry information in real time.

The tracking device is enabled with unique tag or unique Mac address. So, each tracking device has different unique tag or unique Mac address assigned for each participant and the information associated with positioning, tracking and streaming is displayed on web interface configured with customer player accordingly.

The tracking device distributes a signal or telemetry information and also progress with change in location or direction in real time. The signal or telemetry information may be received at different times and with different frequencies in respect to change in participant or player location or direction. Meanwhile, signal or telemetry information may be received more regularly, for example every second.

The plurality of camera is automatically aimed to stream video of a participant or player. Cameras are located in multiple locations out of which are mostly fixed cameras and also some cameras are provided for individual streaming. The tracking devices locate signal or telemetry information and by using telemetry information able to determine the relative position between camera locations. This information can be used to create a software zoom of the camera feed. If the participant or player is close to the camera then show the direct feed. However, if the participant or player is some distance from the fixed camera then zoom the feed on that participant or player.

The cameras are deployed relative to the route or playing ground such that some cameras cover section of the route or playing ground and some are directly fixed to stream participant or player. Two or more cameras may overlap to some degree. Preferably, the participant or player is individually identified by an operator with the aid of an additional remotely controlled pan/tilt/zoom camera (“camera for individual streaming”). The “camera for individual streaming” is automatically aimed to the predicted location of a player “lost” by the system (i.e. the system cannot identify any more) and provides a high magnification view of the player to the operator. The “camera for individual streaming” is located in multiple locations (in addition to the fixed). The “camera for individual streaming” is used to automatically zoom in and to provide high magnification views of the participant or player from multiple directions. These views are provided to an additional identification of participant or player.

The antenna is to monitor or identify meta-data of tag or Mac address of BLE or NFC or RFID or GPS satellite associated with the tracking device and transmits location of the tracking device accordingly to server(s).

The one or more cameras is/are positioned at multiple location relative to route or playing ground to stream video of the participant or player and the event. These cameras are focused on participant or player and configured to capture video of the participant or player and event for live streaming.

The processor which is in communication between tracking device, antenna and plurality of cameras is operative to coordinate and receive information and transmit the said information to server(s), the information can be selected form position information, speed information or direction information.

In this regard, the server(s) provides real-time positioning, tracking and streaming of participant or player and delivers streams for progress of the participant or player and the event in real time on web interface configured with custom player. Wherein, the server(s) is/are linked to Social Media or other networking groups (Facebook, twitter, LinkedIn etc) in synchronization with the information associated with positioning, tracking and streaming.

The real-time location information for each participant or player is configured with tracking device through registration. A tag identifier is placed in the vicinity of a tracking device which then allows the participant or player to register their account information. In case of alternative embodiment as discussed above for personal device, that uses BLE or NFC or RFID or GPS satellite or Beacon location information and directly broadcast the location information into the custom player on web interface through server network which does not require antenna to identify tag or Mac address of the tracking device. The personal device can be configured with downloadable app that allows the participant or player to register information.

Once registered, the participant or player can provide a unique link to access a custom player by viewers such as fans, friends, family members or colleagues. The unique link could require further authorization or permissions before access is granted for example that the viewers are a friend on the social media site in which the player is embedded or the viewers are invited using email and that the email requires confirmation before access.

As mentioned previously, the tracking device can be also attached to other individuals associated with the event such as but not limited to sponsor(s), event manager(s) or organizer(s); the present invention is for positioning, tracking and streaming an event for group(s) to see the progress of the other members associated with an event.

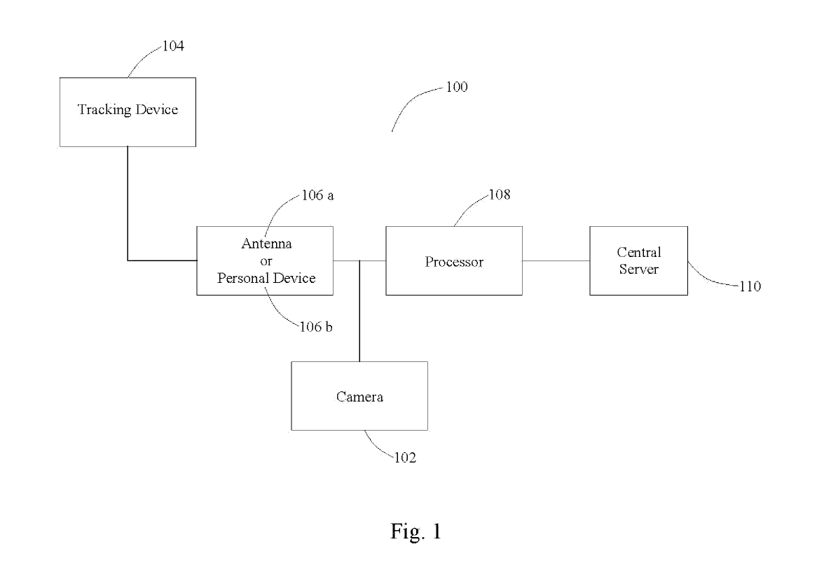

FIG. 1 shows, a system 100 comprises a plurality of cameras 102a-n; tracking devices 104a-n can be attached to or wore by participant or player; antenna 106a or personal device 106b that detects signal or telemetry information of the tracking device; a processor 108 configured to communicate with an antenna 106a or a personal device 106b to receive location of the tracking device and transmit location information of said tracking device to server(s) 110 to provide real time positioning, tracking and streaming of participant or player and delivering streams for progress of the participant or player and the event.

The processor 108 may also comprises a structured configuration of the route or playing ground. This structured configuration may be an accurate and detailed geometry of the route or playing ground in a simple line and curve representation. More generally, the processor is operable to represent a location of distance from a predetermined reference point (such as a starting line). The distance may be expressed in real units (such as meters) or arbitrary units (such as a percentage of the mean track length).

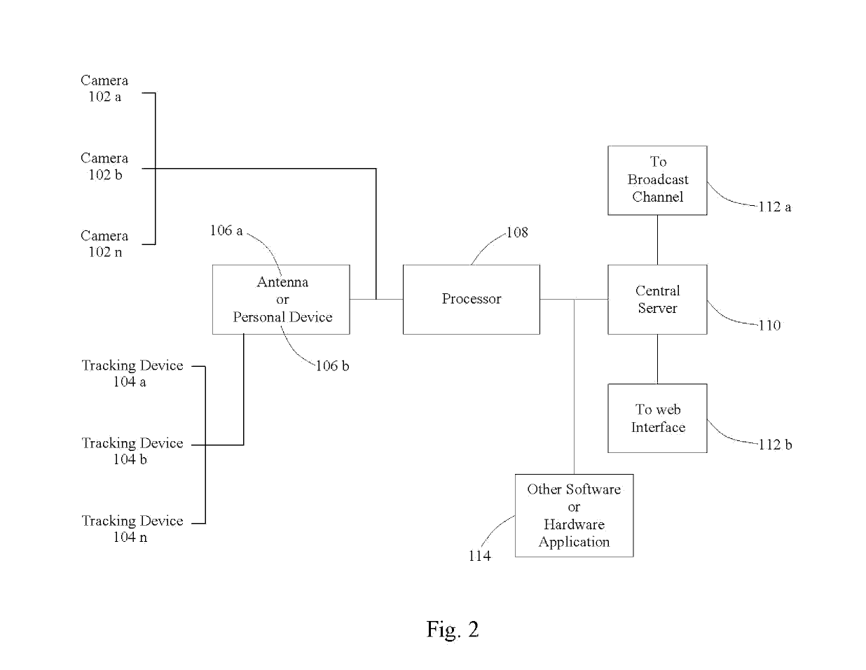

FIG. 2 shows detailed block diagram of a system 100 comprises a plurality of cameras 102a-n (n being any integer greater than 1) arranged in a spatial relationship to a route or playing ground (not shown); tracking devices 104a-n (n being any integer greater than 1) can be attached to or wore by participant or player for obtaining signal or telemetry information of the present location; antenna 106a or personal device 106b is to monitor or identify tag or Mac address and detects signal or telemetry information of the tracking device 104a-n; a processor 108 configured to communicate with an antenna 106a or a personal device 106b to receive location of the tracking device and transmit location information of said tracking device to server(s) 110 and a server(s) 110 broadcast the streaming video of progress of participant or player and event via broadcasting channel 112a or through web interface 112b configured with custom player. Moreover, the various modules of the systems described herein can be implemented with other software or hardware applications 114, software and/or hardware modules, or components on one or more computers.

To view the live positioning, tracking and streaming of participant or player and event, the server provide the same to the viewers in form of pre-registration; including being fans, friends, family members or colleagues or through membership.

Also, the server is configured with participant or player profile and a representation of the predetermined route or playing ground, and operable to receive a position of the one or more participant or player with respect to the representation of the predetermined route or playing ground.

The server(s) includes provision to create profile of each participant or player for presenting position, tracking information and delivering streams of progress of the participant or player and the event in real time. An output is a graphical overlay custom player on the web interface from server(s) feeds of tracking information and streaming live video.

As mentioned previously, the real-time tracking in live is provided by obtaining continuous tracking information or location information by tracking device associated with participant or player in the event.

Multiple viewers can be invited by the participant or player being tracked to watch their progress as if they were being followed by plurality of camera. These cameras are prefixed on the route or playing ground or also some of the camera are carried by camera person to capture video frame of the participant or player.

A custom player is on web interface is configured for switching streams between cameras for the participant or player. The custom player allows the streams for which streams are viewed for which participant and are determined by tracking information using tracking device.

A switching between streams is automatic or manual process or both. In aromatic process, for example a first stream received from a camera is played with particular participant or player. Any change in signal or telemetry information adjacent to the other camera is detected, resulting in executing a procedure for deciding whether to switch from playing the first stream to playing a second stream differing from the first stream. The executed procedure decides to make the switch. The switch is made to playing the second stream as the second stream is being received on server in response in change in tracking information from the tracking device. The switching between streams preserves continuity of the video for the participant or player and also continuity in change in tracking information by tracking device. In manual process, the viewer can switch the stream for the participant or player he/she may interest to view.

A process of switching streams begins with the custom player loading a received video in the memory. The received video designates a specific stream associated with change in tracking information by tracking device. The change in tracking information by tracking device designates video stream to switch to based on a detected change in tracking information.

Moreover, the custom player is a media application checks for the change in tracking information which may trigger the camera to switch to a new stream. Switching streams of a video in accordance with embodiments of the present invention enables video to be provided to the multiple viewers in an efficient manner that is convenient for multiple viewer to view the continuous stream of the participant or player.

In another embodiment of the present invention is a method for positioning, tracking and streaming sports event, the method comprising; detecting tracking device; receiving signal or telemetry information of the tracking device; transmitting location information of the tracking device to the server(s); requesting video from plurality of cameras positioned at multiple locations relative to route or playing ground; streaming video in respect with progress of participant or player and event; and providing real-time positioning, tracking and streaming of participant or player and delivering streams for progress of the participant or player and the event in live on web interface configured with custom player.

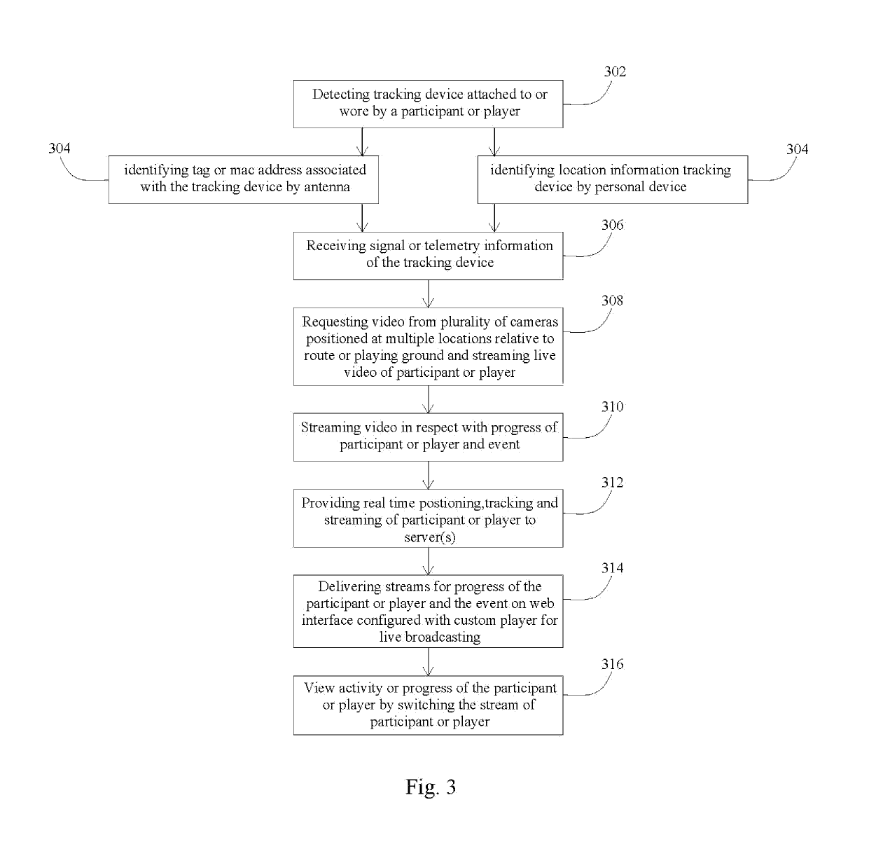

FIG. 3 shows an exemplary process of method of positioning, tracking and streaming tracking participant or player and event: in first step 302 detecting tracking device attached to or wore by a participant or player; in second step 304 identifying tag or Mac address associated with the tracking device by antenna or indentifying location information tracking device by personal device; in thirds step 306 receiving signal or telemetry information of the tracking device; in forth step 308 requesting video from plurality of cameras positioned at multiple locations relative to route or playing ground and streaming live video of the participant or player; in fifth step 310 streaming video in respect with progress of participant or player and event; in sixth step 312 providing real-time positioning, tracking and streaming of participant or player to the server, in seventh step 314 delivering streams for progress of the participant or player and the event on web interface configured with custom player for live broadcasting and in last step 316, the multiple viewer who are viewing the event through internet connection can view activity or progress of the participant or player and also switch the stream of his/her choice of participant or player.

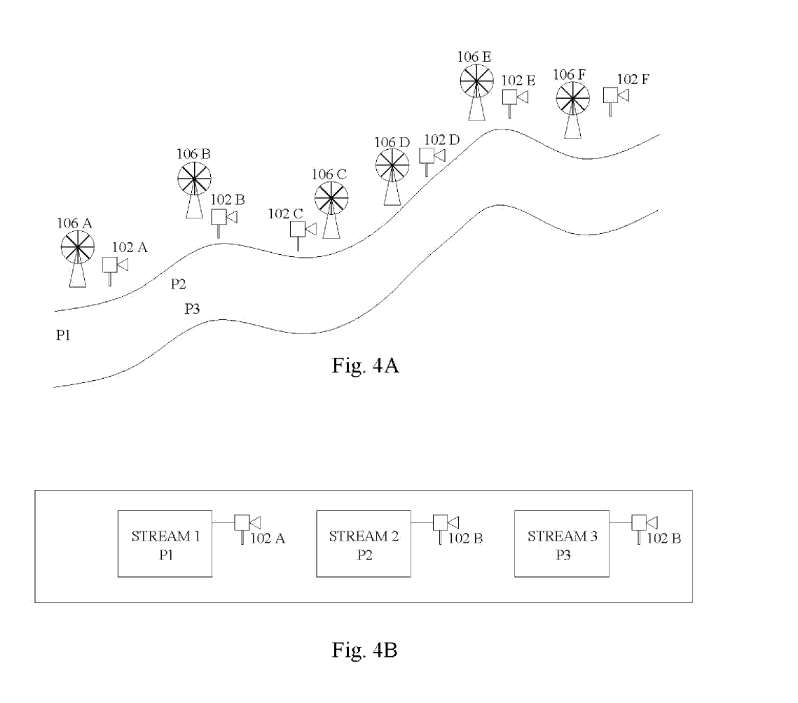

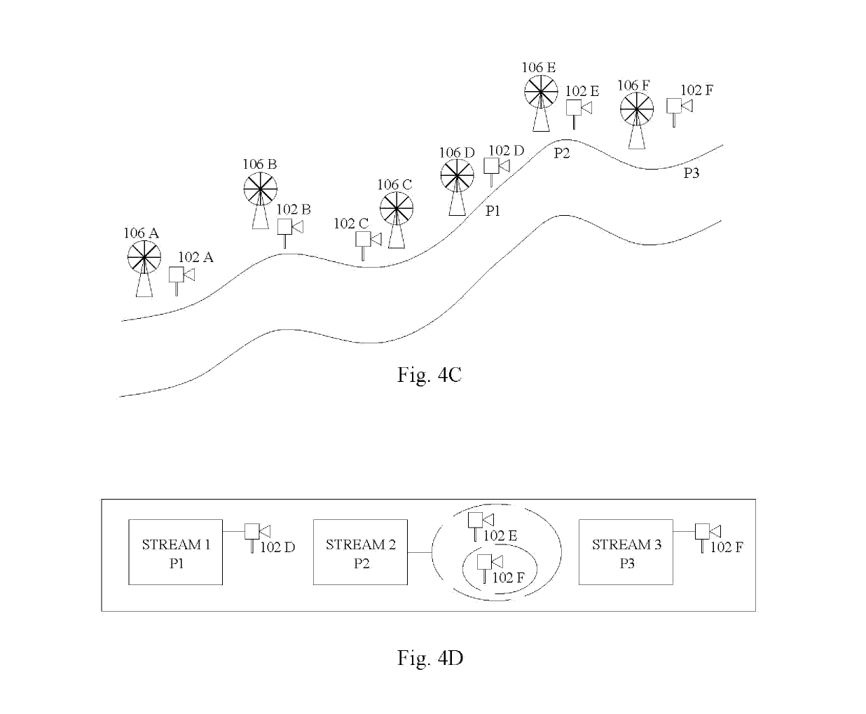

Referring now to FIG. 4A, FIG. 4B, FIG. 4C and FIG. 4D shows an exemplary embodiment of the present invention. In FIG. 4A, there is depicted a plurality of camera (102A-F) at fixed point in a marathon race event or more generally any sport event following a predetermined path, such as a horse race, a cycle race, car race or the like. Optionally the path may be discretely defined. Also a plurality of antenna (106 A-F) is configured on fixed point in a route or playing ground or predetermined path. However, participants or players P1-P3 are shown for illustrative purpose in time A but it can be 10,000s or more participant or player.

FIG. 4B is the video streams of participant or player of FIG. 4A at a time A, the video stream of participant or player in live on web interface configured with custom player is shown. As shown in the custom player, stream1 is video stream of participant or player P1 is that of camera 102A, because participant or player P1 is close to antenna 106A. The stream2 is video stream of participant or player P2 is that of camera 102B, because participant or player P2 is close to antenna 106B and signal of antenna 106B is now stronger than antenna 106A, which indicates that camera 102B is most suitable. Similarly, stream3 is video stream of participant or player P3 is that of camera 102B, because participant or player P3 is close to antenna 106B and signal of antenna 106B is now stronger than antennas 106A and 106C.

Again, FIG. 4C shows progress of the participant or player and the event in live on web interface configured with custom player for Time B. In time B, the location of the participant or player P1-P3 is shown with different location.

FIG. 4D is the video streams of participant or player P1-P3 of FIG. 4C at time B. As shown in the custom player, stream1 is video stream of participant or player P1 is that of camera 102D, because participant or player P1 is close to antenna 106D. The stream2 is video stream of participant or player P2 is that of camera 102E or 102F, because participant or player P2 as signal of antennas 106E and 106F indicate that participant or player P2 can be viewed by both cameras 102E and 102F. In this case, it is possible to show both camera 102E and 102F as picture-in-picture; or switches stream between cameras. Similarly, stream3 is video stream of participant or player P3 is that of camera 102F, because participant or player P3 is close to antenna 106F and where signal of antenna 106F is now stronger than antennas 106E. Therefore, in exemplary embodiment of the present invention FIG. 4A, FIG. 4B, FIG. 4C and FIG. 4D illustrate that when signal of the antenna goes weaker to nearby cameras, the custom player automatically switches stream of another camera for video stream of participant or player.

Naturally, and as can be seen from the above, the invention is not limited in any way to the application and the implementations described specifically above, on the contrary, the invention covers numerous variants.

It will be apparent to a person skilled in the art that variations in the above method corresponding to operation of the various embodiments of the invention as described and claimed herein are considered within the scope of the present disclosure.

One skilled in the art will appreciate that the embodiments provided above are exemplary and in no way limit the present invention.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

Moreover, the various modules of the systems described herein can be implemented as software applications, hardware and/or software modules, or components on one or more computers, such as server(s). While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

The Abstract of the disclosure will allow the reader to quickly ascertain the nature of the technical disclosure. It is submitted with the understanding that it will not be used to interpret or limit the scope or meaning of the following claims.

What is claimed is:

1. A system for positioning, tracking and streaming event, comprising:
at least one tracking device;
at least one antenna which detects signal or telemetry information of the tracking device;
plurality of cameras positioned at multiple location relative to route or playing ground focusing on participant or player and operative to stream video of the participant or player and the event;
one or more processors which is in communication with tracking device, antenna and plurality of cameras; and
server(s) configured to provide real-time positioning, tracking and streaming of participant or player and delivering streams for progress of the participant or player and the event in live on web interface configured with custom player.

2. The system of claim 1, wherein the tracking device is attached to or wore by a participant or player and also can be attached to or wore by others associated with the event such as but not limited to sponsors, event manager or organizer

3. The system of claim 1, wherein tracking devices locate a signal or telemetry information and progress with change in telemetry information in real time.

4. The system of claim 1, wherein the tracking device configured with but not limited to BLE or NFC or RFID or GPS satellite.

5. The system of claim 1, wherein the antenna is to monitor or identify meta data of tag or Mac address of BLE or NFC or RFID or GPS satellite associated with the tracking device and transmit location of the tracking device accordingly to a server(s).

6. The system of claim 1, wherein plurality camera configured to capture video of one or more participant or player in real time.

7. The system of claim 1, wherein antenna have telemetry sensors association with tracking device, which is to receive signal or telemetry information and output signal or telemetry information to processor in real time.

8. The system of claim 1, wherein the server(s) is/are linked to Social Media or other networking groups in synchronization with the information associated with positioning, tracking and streaming.

9. The system of claim 1, wherein the server(s) deliver information associated with positioning, tracking and streaming to custom player for presenting to multiple viewers in form of pre-registration; including being fans, friends, family members or colleagues or through membership.

10. The system of claim 1, wherein the processor which is in communication with tracking device, antenna and plurality of cameras is operative to coordinate and receive information and transmit the said information to server(s), the information can be selected form position information, speed information or direction information.

11. The system of claim 1, wherein the custom player is configured to request for video streams associated with each of the participant or player with reference to progress in real time and configured to operate for switching stream according to the participant or player with tracking device and tracking information.

12. A system for positioning, tracking and streaming event, comprising:
at least one tracking device;
a personal device such as mobile phone;
plurality of cameras positioned at multiple location relative to route or playing ground focusing on participant or player and operative to stream video of the participant or player and the event;
one or more processors which is in communication with personal device and plurality of cameras; and
server(s) configured to provide real-time positioning, tracking and streaming of participant or player and delivering streams for progress of the participant or player and the event in live on web interface configured with custom player.

13. The system of claim 13, wherein the personal device uses local tacking local tracking such as but not limited to BLE or NFC or RFID; or GPS or similar technology such as WPS or WIFI position system for positioning and then transmitting the location information of to cloud or server(s) using the personal device internet connection.

14. The system of claim 1, wherein the processor which is in communication with tracking device, antenna and plurality of cameras is operative to coordinate and receive information and transmit the said information to server(s), the information can be selected form position information, speed information or direction information.

15. The system of claim 1, wherein the server(s) is/are linked to Social Media or other networking groups in synchronization with the information associated with positioning, tracking and streaming.

16. The system of claim 1, wherein the custom player is configured to request for video streams associated with each of the participant or player with reference to progress in real time and configured to operate for switching stream according to the participant or player with tracking device and tracking information.

17. A method for positioning, tracking and streaming sports event, the method comprising;
detecting tracking device;
receiving signal or telemetry information of the tracking device;
transmitting location information of the tracking device to the server(s);
requesting video from plurality of cameras positioned at multiple locations relative to route or playing ground;
streaming video in respect with progress of participant or player and event; and
providing real-time positioning, tracking and streaming of participant or player and delivering streams for progress of the participant or player and the event in live on web interface configured with custom player.
